(19) United States
(12) Patent Application Publication
(10) Pub. No.: US 2004/0031953 A1
(43) Pub. Date: Feb. 19, 2004

(54) A-coil jacks and method of removing furnaces

(76) Inventor: Paul Leggett, Jackson, MS (US)

Correspondence Address: William D. Breneman, Esq., BRENEMAN & GEORGES, 3150 Commonwealth Avenue, Alexandria, VA, 22305, US

(21) Appl. No.: 10/217,682

(22) Filed: Aug. 14, 2002

(51) Int. Cl. B66F 1/00

(52) U.S. Cl. 254/1

(57) ABSTRACT

A novel pair of jacks and method for separating A-coils from furnaces to allow the removal or replacement of furnaces is provided having at one end a pair of lift plates, stabilization cord and tensioning mechanisms for tensioning the stabilization cord and stabilizing the pair of jacks with respect to the A-coil housing to allow the removal of the furnace housing and storage of the A-coil housing on the novel stabilized pair of jacks. The novel pair of jacks include a lifting mechanism and handle for lifting the lift plates and thereafter storing the handle while simultaneously locking the release mechanism. A scotching mechanism may also be provided to prevent damage to the novel jacks from improper use.

### BACKGROUND OF THE INVENTION

1. Field of the Invention

The invention pertains to a novel jack for separating the A-coil from a furnace as well as a method for removing furnaces from A-coils. More particularly, the invention pertains to a novel pair of jacks, each having an A-coil supporting lip interconnected with a cord for lifting opposite sides of an A-coil to separate an A-coil housing from a furnace housing and then tensioning the cord between the A-cord supporting lips to stabilize the novel A-coil jacks and allow the A-coil to be elevated to a stored position for subsequent removal of the furnace housing from between the novel A-coil supporting jacks. The novel A-coil jacks include a stand, novel lifting mechanism and safety mechanism for locking the release mechanism as well as the novel A-coil supporting lip mechanism which includes A-coil support lips, tie cord interconnection between the A-coil supporting lips and a tensioning device for tensioning the A-coil supporting lips to the A-coil housing and support and store the A-coil housing and allow the removal of the furnace housing.

The method of the invention includes the steps of simultaneously jacking opposing sides of an A-coil housing to separate the A-coil housing from the furnace housing and then tensioning an interconnecting tension cord between the jacks to stabilize the tops of the jacks and allow the furnace housing to be removed from between the pair of novel jacks while the A-coil housing is in an elevated stored position while the supporting lip mechanism stabilizes the tops of the jacks tensioned against the A-coil housing.

2. Description of the Related Art Including Information Disclosed Under 37 CFR 1.97 and 1.98

The prior art method of removing furnaces and separating an A-coils housing from a furnace housing involved the presence of two or three men to separate the A-coil housing from the furnace housing by first disconnecting A-coil drain lines and then having one or two men lift the A-coil housing while one or more of the men slide the furnace housing out from beneath the A-coil housing and then providing a makeshift platform for supporting the A-coil housing. Alternatively separation of the A-coil housing has been accomplished by providing a makeshift hoist utilizing rafters or other available portions of the structure of the house to serve as a support for a hoist to lift the A-coil from the furnace while one or two men slide the furnace out from beneath the hoisted A-coil housing.

The prior art methods of separating A-coil housings from furnace housings is further complicated by the fact that furnaces and A-coils are generally located within confined or tightly constricted areas that make the removal of the furnace from the A-coil a time consuming and labor intensive process in which workmen are in each other's way in the generally confined space.

The problem of separating the A-coil housing from the furnace is further complicated by the fact the A-coil housing is connected to duct work and has to be maintained in a slightly elevated position to remove the furnace housing and then be repositioned and placed back over the furnace housing once the furnace is repaired or replaced which again requires the placement of the A-coil housing back over the lip of the furnace housing to join the A-coil housing and furnace housing back together.

The known prior art does not provide for the jacking and storing of the A-coil housing on a pair of jacks or the utilization of a tensioning device to tension the A-coil supporting lip to the body of the A-coil housing to provide a secure and established connection between the A-coil jacks and the A-coil housing. The novel jacks and method of the invention provide a convenient storage position for the A-coil housing while the furnace housing is removed from beneath the A-coil housing while the novel jacks support the A-coil housing on a pair of stabilizing supporting lip mechanisms tied together with a tie cord between the stabilizing supporting lip mechanisms on the novel A-coil jacks.

The prior art includes various interconnected jacking devices for jacking opposing sides of articles such as boats Sadler U.S. Pat. No. 4,072,293 vehicles, Nestel-Eichhausen U.S. Pat. No. 4,776,569, farm wagon(s) Wenigar U.S. Pat. No. 2,525,983 and cylindrical tanks Morgan U.S. Pat. No. 2,993,679. None of these prior art jacks for jacking various articles teach or suggest the novel pair of jacks of the invention which provide an A-coil supporting lip mechanism for first prying in between the A-coil housing and the furnace housing and then supporting the A-coil housing to lift the A-coil housing for about an inch until the A-coil is separated from the vertical lip of the furnace before the tensioning cord between the A-coil supporting lip mechanism is pulled tight to stabilize the novel jacks to each other and the A-coil housing to allow further lifting of the A-coil housing from the furnace housing to an A-coil housing stored position to provide the necessary room to separate the A-coil housing from the furnace housing to allow the furnace housing to be removed from underneath the stored in position elevated A-coil housing.

The prior art boat jacks of Sadler U.S. Pat. No. 4,073,293 include a connecting chain between conventional moveable jacks which does not function to pry or adjustably tension the lifting member against the boat or stabilize the jacks. In addition Nestel-Eichhausen U.S. Pat. No. 4,776,569, like Sadler U.S. Pat. No. 4,072,293 merely interconnects two jacks with a steel bar.

Prior art such as Wenigar U.S. Pat. No. 2,525,983 provides jacks interconnected with a cable 32 that passes through an elongated roller tube to provide for the hoisting of trailers and farm wagons. The cable of Wenigar U.S. Pat. No. 2,525,983 does not pry or function as a tensioning mechanism to stabilize the lifting element against the sides of a structure being lifted. Morgan U.S. Pat. No. 2,993,697 provides for a hoisting apparatus for cylindrical tanks which utilize a plurality of jacks around the inside perimeter of a tank having welded plates in which cables are connected to the eye-members of the jacks to assist in steadying the jacks with respect to one another to prevent accidental movement or shifting. Morgan U.S. Pat. No. 2,993,697 employs a tensioning system for a jack having supporting lips disposed on opposite sides in which a tensioning cable is tensioned between the supporting lips to engage the supporting lips between the housing and the supporting lips. The Morgan U.S. Pat. No. 2,993,697 do not function to pry or to tension the tops of the jacks against the lifted tank.

The prior art also includes a number of jacking mechanisms such as Wurdack U.S. Pat. No. 5,385,335, Baron, et al. U.S. Pat. No. 4,084,792, Wille U.S. Pat. No. 4,552,337, Lucker U.S. Pat. No. 2,239,268 and Zinke U.S. Pat. No. 2,718,253. These prior art patents for the jacking mechanism are different from the jacking mechanism of the invention in that the jack handle does not include a multifunctional pivoted handle and roller which pivots to operate a lift dog and then pivots to provide a stored locking position for exerting a downward roller force on the brake release to lock the brake release at the same time the handle is in the stowed position so as not to interfere with the removal of an object between the pair of supporting jacks. Further the jacking mechanisms of the prior art do not include slots which allow both jacks to be jacked simultaneously to elevate each of the independent jacking bars to coordinate vertical lift. Further the prior art jacking mechanisms do not include a cord or tie member for tying together the tops of the pair of jacks to stabilize the jacks with respect to each other and a load disposed at the end of the pair of jacks.

The prior art jack mechanisms do not provide for a coordination of the lifting elements of a pair of jacks that allows each jack to be raised in precise increments with a multifunctional handle for leveraging a spring loaded lift dog against a jacking bar to release tension on a brake release and allow the jacking bar to be raised and when pressure is released from the jacking handle the spring tensioner between the lift dog and the brake release locks the jacking bar in the incremental raised position. This incremental jacking process is repeated on both jacks resulting in the coordinated lifting of the A-coil since each jack is designed to raise the jacking bar about one half inch to an inch with each pivot of the jacking handle of the novel A-coil lifting jack in the jacking position. Thereafter the jack handles are pivoted to the stored position for locking the brake releases.

The prior art also does not provide a jack with a scotching mechanism that prevents damage to the jack mechanism from an improper use of the jack or using the jack beyond its design capabilities. The scotching mechanism includes a spring loaded scotching insert biasing against the jacking end of the lift dog to prevent the locking end of the lift dog from biting into the jacking bar.

None of the prior art provides for storage of the A-coil housing on a lifting jack while the furnace housing is removed, repaired or replaced or provides for the convenient disposition of the A-coil housing in the same but slightly elevated position as it was prior to its separation from the furnace. Further, none of the prior art teaches or suggests the separation of the A-coil housing and removal of the furnace housing by a single heating and cooling specialist. Additional differences between the invention and the prior art will become more apparent from the following brief Summary Of The Invention.

### SUMMARY OF THE INVENTION

The invention provides a novel pair of A-coil jacks and method for separating an A-coil housing from a furnace housing and providing for the storage of the A-coil housing during the removal of the furnace housing. The method of the invention allows the separation and convenient storage of the A-coil housing in a position above the removed furnace housing without significantly interfering with existing duct connections to the A-coil housing allowing the repaired or replacement furnace housing to be repositioned between the novel A-coil jacks and the stored A-coil housing to be lowered and replaced on the furnace housing in substantially the same position from which it had been separated.

The novel A-coil jack allow one man to remove and separate an A-coil housing from a furnace housing which heretofore was a cumbersome operation involving two or more servicemen that required removal or storage of the A-coil housing on makeshift supports or at an inconvenient location.

The novel pair of A-coil jacks include a pair of confronting A-coil supporting lip mechanisms for prying and wedging between the top of the furnace housing and the bottom of the A-coil housing to provide a space for the tensioning of a interconnecting rope or cable to interconnect the tops of the jacks or the novel A-coil supporting lip mechanisms and preferably the lip mechanisms to each other in a tensioning mechanism for tensioning the pair of jacks to each other and to the A-coil housing while the jack actuator handles for the novel jacks provides for the coordinated elevation of the stabilized jacks and the complete separation of the A-coil housing from the furnace housing. The novel A-coil jacks each include a separate novel lifting mechanism which includes a two position jacking bar pivotally angled between a lift dog and a brake release in combination with a lift dog guide slot.

The combination of lift dog, spacer springs and a brake release in combination with the two position jack handle is pivotally mounted to a housing having the lift dog guide slot to provide for the incremental lifting of the lift dog. The lift dog guide slot on both jacks is the same to allow each pivoted jack handle to advance each jacking bar through the coaction of the springs and brake release to incrementally and coordinatedly advance each jacking bar to lift the A-coil housing. Both jack handles are pivotally mounted with respect to the lift dogs and brake releases of each jacking bar so that a same incremental travel of the jack handle results in a synchronized advancement of both of the jacking bars.

Once the A-coil has been separated a sufficient distance by the action of the jack handles the jack handles on both jacks are designed to pivot upwardly in a stored position to lock the brake release to store the jack handles in a position away from the furnace housing and prevent the accidental release of the locking mechanism. The stored position of the jack handles also clears an area around the furnace to assist in the removal of the furnace housing from between the novel A-coil jacks. The pivotable stowed position of the jack handles are in a stowed position substantially parallel to the jacking bar of each jack to assist in the removal of the furnace housing from between the novel A-coil jacks.

The novel A-coil jacks in the preferred embodiment includes a pair of legs interconnected by a cross support which provides support for a housing for carrying an extension mechanism for the jacking bar to accommodate furnaces of varying heights. In the best mode of the invention the jacking mechanism includes a scotching mechanism to prevent jamming of the lift dog into the jacking bar resulting from improper use of the jacks or by exceeding the weight design capacity of the novel jacks.

In the preferred embodiment of the invention the top end of the jacking bar is designed to accommodate an extension element having a plurality of adjustable position holes for accommodating furnaces of varying heights. This extension element preferably includes a slot at one end for receiving the end of the jacking bar and a jacking bar extension end for engaging the slot in the lift plate mechanism. The extension element may also be a telescopying adjustment on the jacking bar to accommodate furnace housings of varying heights from about 4 feet high to 8 feet high. Alternatively the extension element may include a separate supporting lip mechanism. In all embodiments of the invention the top of the lifting bar of the jacks or the lift plate elements on the top of the jacks which include the supporting lip mechanism are designed to receive a cord or cable or other tensioning device such as a bungee cord for stabilizing the tops of the novel jack to laterally secure the sides of the jack against the bottom of the housing of the A-coil.

The method of the invention includes the steps of placing one each of the novel pair of A-jacks against the side of the furnace so that the base and sides of the A-jacks are about 2 to 8 inches and preferably 3 to 4 inches each away from the sides of the furnace to provide clearance for removing the furnace and allow the lift plate supporting lip mechanism at the end of the jacks to pry between the seam between the housing of the A-coil and the furnace. The handles of both of the A-jacks are then activated to slightly raise the A-coils on the supporting lip mechanism from about 1 to 8 inches and preferably 3 to 4 inches before the cord connecting the tops of the A-jacks is pulled tight and tensioned between the pair of A-jacks to tightly engage the supporting lip mechanism against the sides of the A-coil housing and underneath the A-coil housing.

As slack is pulled from the cord or where a type of bungee cord is utilized the cord is stretched so that all slack and a slight tension is maintained between the tops of the A-jacks before the coil is wrapped around the tension mechanism. In the case of a wire cable a ratcheting tension mechanism may be utilized to remove all slack in the cable and positively provide a tension force between the tops of the jacks and the coil. In the preferred embodiment a nylon rope or cord is employed in combination with a friction type tension mechanism. Once the tension cord is tensioned to provide stability between the jacks, both A-jacks are raised using the jack handles until a desired distance between the top of the furnace and the bottom above the A-coil is obtained.

The A-coil is then secured in an elevated stored position by locking the jack handles in an upright position substantially parallel to the jacking bar to lock the brake release and prevent accidental release of the jacking bar and move the handles away from interfering with the removal of the furnace housing. The furnace housing is then removed from underneath the A-coil housing and the furnace is repaired or replaced while the A-coil remains in a stored position above the location from which it was removed.

Once the furnace has been repaired or replaced by sliding a furnace housing back in between the pair of novel A-jacks the jack handle is moved down from its locked position to release its downward pressure on the brake release and the brake release on both jacks are released to allow the A-coil housing to slowly descend over the lip of the furnace to allow the A-coil and furnace to be mated together in substantially the same vertical arrangement as they previously occupied.

In the preferred embodiment of the invention the novel A-jacks include a brake tensioner for providing additional control over the speed of retraction of the jacking bar to adjust the speed of the descent of the A-coil housing over the furnace housing. In addition a brake lock adjustment may also be provided to adjust the position of the jack handle in the stored position as well as increase or decrease the amount of tension on the brake release. Further advantages of the invention will become apparent with reference to the following Brief Description Of The Drawings in conjunction with the Detailed Description Of The Invention.

### BRIEF DESCRIPTION OF THE SEVERAL VIEWS OF THE DRAWINGS

The invention will be hereinafter more fully described with reference to exemplary illustrations of the preferred embodiments of the invention, in which:

FIG. 1 is a side elevational view of an A-coil housing, furnace housing and novel jack that also illustrates a step in the method of the invention;

FIG. 2 is a rear elevational view of FIG. 1 illustrating a further step in the method of the invention;

FIG. 3 is an enlarged elevational view of a portion of the lip supporting mechanism as reference circled in FIG. 2;

FIG. 4 is a front elevational view of the lip supporting mechanism including lift plates and stabilizing cord for stabilizing the novel A-jack of the invention;

FIG. 5 is a side elevational view of the top of the novel A-jack and lift plate and tensioning mechanism in accordance with the best mode of the invention;

FIG. 6 is a side elevational view with one of the housing plates removed to illustrate the jacking mechanism;

FIG. 7 is a further side elevational view with one of the housing plates removed to illustrate the lifting action of the jacking mechanism of the novel jacks;

FIG. 8 is a side elevational view with one of the housing plates removed further illustrating in phantom the various components of the novel lifting jack and the pivoting jack handle to a stored position to lock the release mechanism in accordance with the invention;

FIG. 9 is a perspective view of the top portion of a tensioning mechanism of the novel lifting jack and a portion of the jacking bar;

FIG. 10 is a perspective view of a portion of the nylon guide of the tensioning element in the novel jack of the invention;

FIG. 11 is an alternative embodiment for a jacking bar and tensioning mechanism for a novel jack constructed in accordance with the invention;

FIG. 12 is a perspective view of a nylon guide of the tensioning element of a novel jack constructed in accordance with FIG. 11;

FIG. 13 is a side elevational view Qf an alternative embodiment for a supporting lip mechanism and lift plate with an adjustable stabilizer in accordance with the invention;

FIG. 14 is a side elevational view and an alternative embodiment of a novel supporting lip mechanism and lift plate constructed in accordance with the invention;

FIG. 15 is a perspective view of a further embodiment of a supporting lip mechanism and lift plate for a novel jack constructed in accordance with the invention;

FIG. 16 is a side elevational view of the supporting lip mechanism and lift plates and tops of the novel A-jacks in accordance with an alternative embodiment of the invention;

FIG. 17 is a side elevational view of a housing for a lifting jack constructed in accordance with the invention;

FIG. 18 is a perspective view of a preferred embodiment of a guide and jacking bar components of the novel lifting jack constructed in accordance with the preferred embodiment of the invention;

FIG. 19 is an exploded view illustrating the removal and addition of an extension mechanism for the supporting lip mechanism of the novel jacks of the invention;

FIG. 20 is a side elevational view of an alternative embodiment of a jacking mechanism with a scotching mechanism; and

FIG. 21 is a perspective view of an embodiment of an insert element for a scotching mechanism.

### DETAILED DESCRIPTION OF THE INVENTION

The invention provides a novel jack and method for separating an A-coil housing from a furnace housing and storing the A-coil housing in an elevated position above the furnace without having to remove associated A-coil duct ware. The novel A-coil jacks and methods of the invention as a result maintains the A-coil in a stored elevated position directly over its place of separation so that ducting can remain substantially in place and the furnace housing can be removed, repaired or replaced without having to move or reposition the A-coil housing so that, when the furnace housing is replaced, the A-coil housing is lowered back over the lip of the repaired or replaced furnace housing.

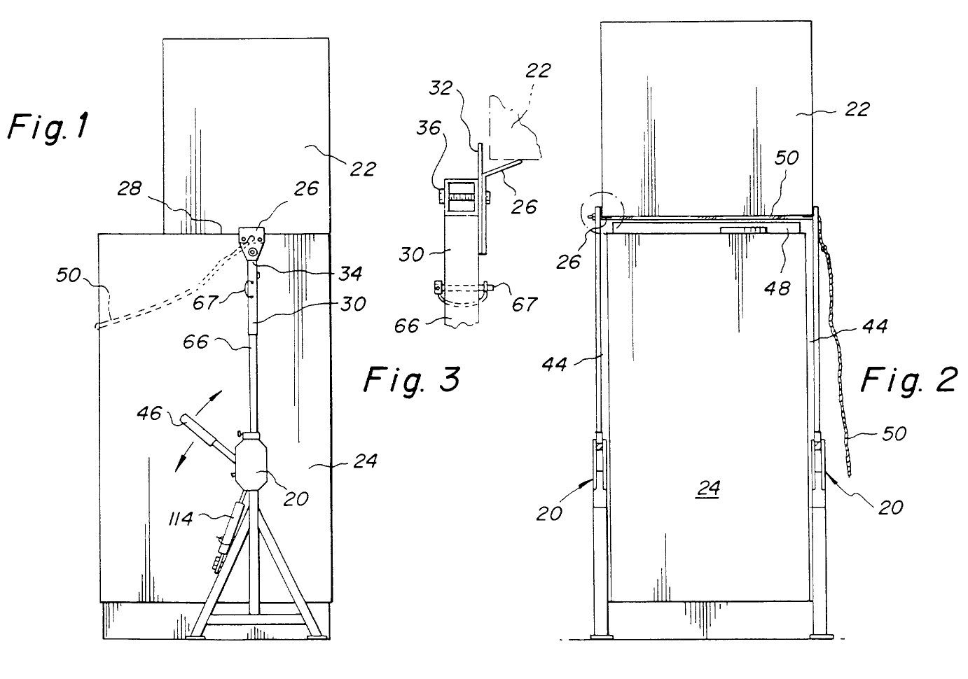

Referring now to FIGS. 1, 2 and 3 a pair of novel jacks 20 are illustrated for separating an A-coil contained an A-coil housing 22 from a furnace housing 24. Each of the A-coil jacks 20 are place on opposite sides of furnace housing 24 and lift plates 26 of each of the jacks 20 are utilized to pry between the seam 28 between the A-coil housing 22 and furnace housing 24.

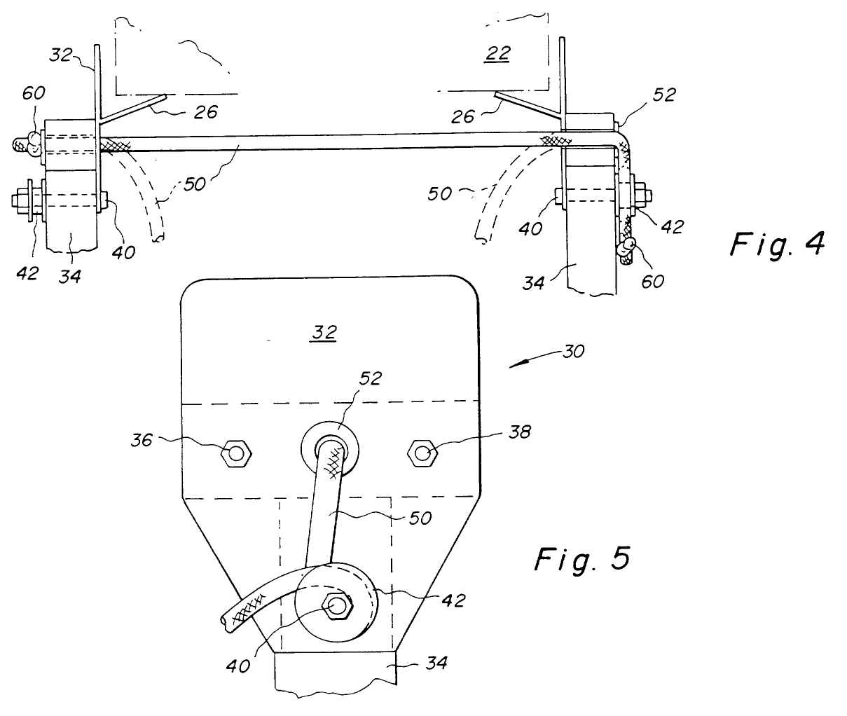

Referring now to FIGS. 1, 2, 3, 4, 5, 13, 14, 15 and 16 the lift plate or supporting lip mechanism 30 is illustrated. The lift plate or supporting lip mechanism 30 includes a lift plate 26 which is bolted, attached or associated with a stabilizer plate 32 which combination of lift plate 26 and stabilizer plate 32 is attached to hollow tube or hollow member 34 with bolts 36 and 38 (FIG. 5) or other fastening means. In the best mode of the invention the lift plates 26 of the novel jacks 20 include a further bolt 40 for attaching the lifting plates to the lift plate or supporting lip mechanism 30 (FIGS. 4, 5, 14 and 16) which bolt 40 includes a tensioning element or a friction lock 42. The tensioning element or friction lock may be constructed of various types of mechanical devices including ratchets, turnbuckles or other such devices for tensioning a cord or wire between the two lift plate mechanisms 30.

The novel jacks 20 are placed alongside furnace housing 24 in such a manner that a space 44 (FIG. 2) of about 2 to 6 inches and preferably 3 to 4 inches exist between the furnace housing 24 and the novel jacks 20 to provide a clearance space for the removal of the furnace housing after the separation of the A-coil housing 22 from the furnace housing 24. Once lift plates 26 are inserted into seam 28 jack handles 46 are simultaneously jacked resulting in lift plates 26 raising the A-coil anywhere from 1 to 6 inches (FIG. 2) so that A-coil housing 24 clears lip 48 of furnace housing 24. Once A-coil housing 22 has cleared lip 48 cord 50 is pulled tight through bushing 52 and tightly secured in friction lock 40 to laterally stabilize the tops of the jacks biasing and tensioning the lift plate mechanisms 30 against the bottom and/or sides of the furnace housing 24.

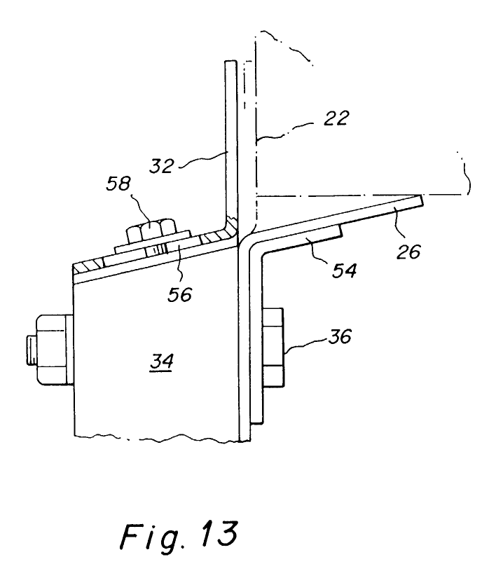

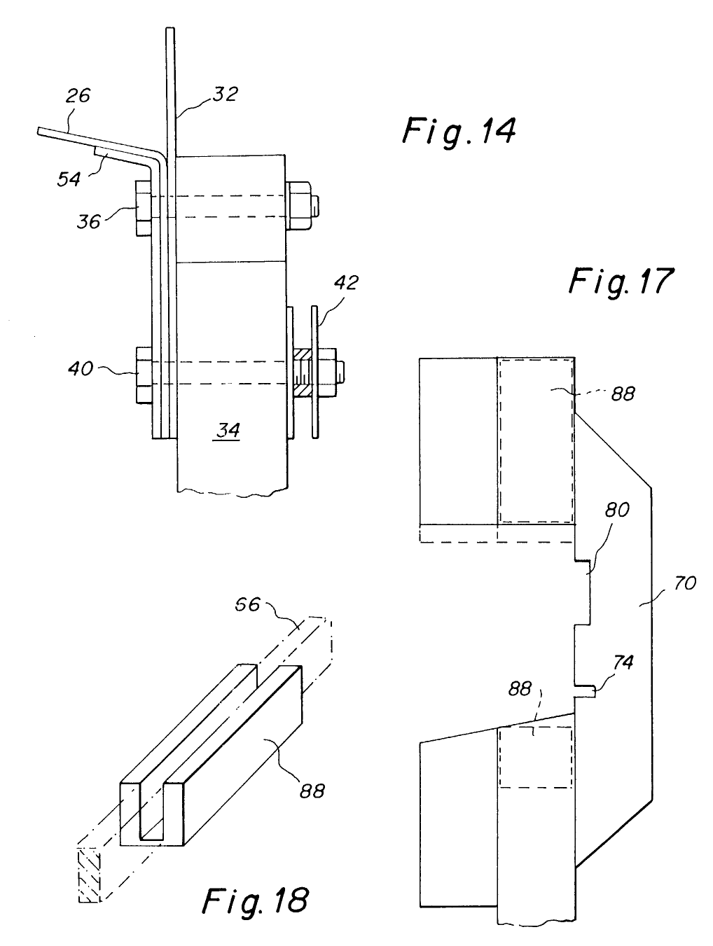

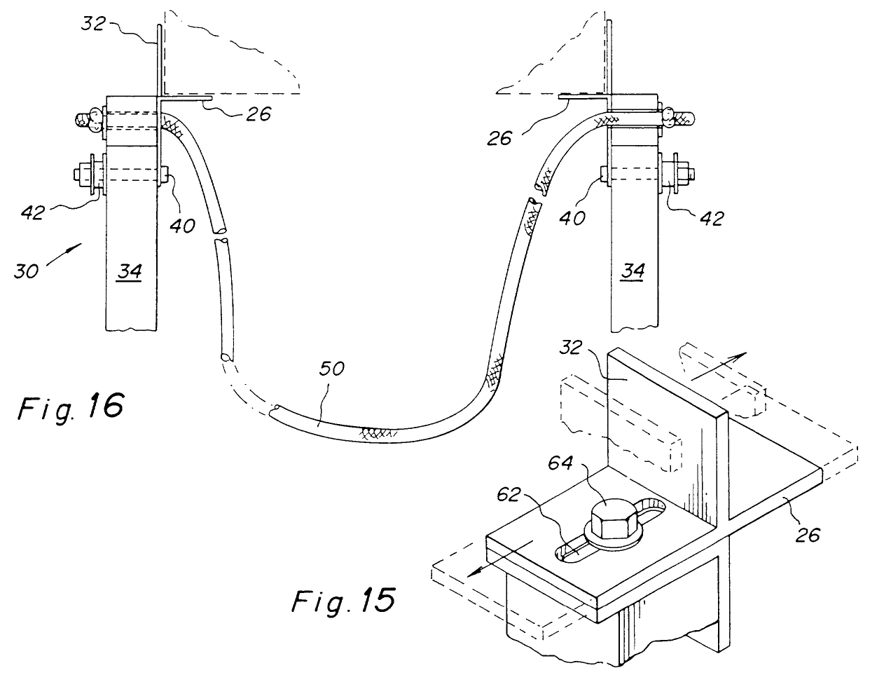

As will be recognized from FIGS. 2, 4, 14, 15 and 16 different arrangements may be provided for lift plate 26. In the preferred embodiment and best mode of the invention lift plate 26 is angled upwardly toward stabilizer plate 32 as illustrated in FIGS. 3, 4, 13 and 14 to assist in the prying between the seam 28 and insertion of the lift plate 26 into seam 28 to separate A-coil housing 22 from furnace housing 24. Alternatively lift plate 26 may be at a right angle to stabilizer plate 32 as illustrated in FIGS. 15 and 16. In addition a reinforcement plate 54 may be added to reinforce lift plate 26 (FIGS. 13 and 14). In addition stabilizer plate 32 may include a slot 56 and bolt 58 for adjustably securing stabilizer plate 32 up against the sides of the A-coil housing 22.

Cord 50 is preferably a nylon or cotton rope that can be pulled tightly and tensioned around and into friction lock 42. Cord 50 however may also be of other materials such as rubber bungee cord materials, wire, plastic or other materials that can be sufficiently tensioned in friction lock 42 to provide stabilization for the lift plate mechanisms 30 between the novel jacks 20. As heretofore described wires can be used with a modified friction lock that includes ratcheting or turnbuckle elements to tension cord 50 between the lift plate or supporting lip mechanism 30. Cord 50 includes knots 60 at either end so that either one end or the other end can be tightly pulled through and attached to friction lock 42. Alternatively cord 50 can be a cable and other types of tensioning mechanisms utilized to tension the cable or cord 50 and tensioning mechanisms provided in the lift plate mechanism 30.

Other forms of supporting lip mechanisms may also be utilized such as illustrated in FIG. 15. In FIG. 15 a lift plate 26 with a stabilizer 32 is provided having a slot 62 and bolt 64 for inserting and adjusting the lift plate 26 against the A-coil housing 22. Alternatively lift plates without adjustment mechanisms as illustrated in FIGS. 3 and 4 may be utilized to separate A-coil housing 22 from furnace housing 24.

Once the A-coil housing 22 and furnace housing 24 are separated and cord 50 is tensioned between the lift plate mechanism at the tops of jacks 20, handles 46 of jacks 20 are simultaneously activated to further raise lift plate mechanism 30 by advancing jacking bar 66. Jacking bar 66 is affixed to the supporting lip mechanism 30 by a clip pen 67 (FIG. 3).

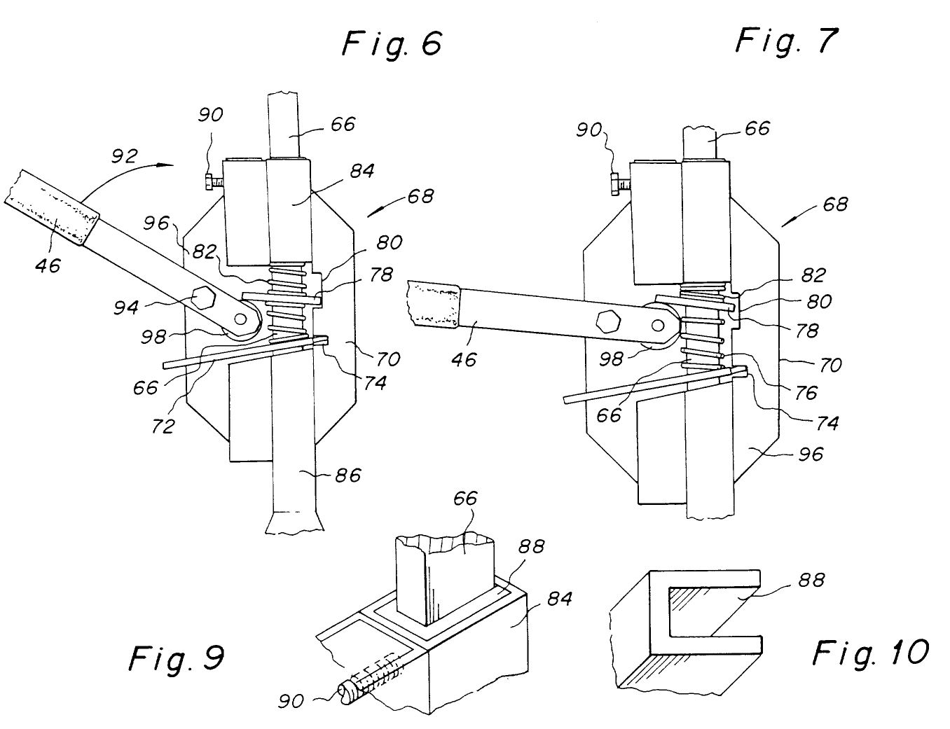

Referring now to FIGS. 6, 7, 9, 10 and 17 and 18 a jacking mechanism for the novel jacks is illustrated. Jacking mechanism 68 includes a jack housing 70 having an angled brake release lever 72 having one end captured in a slot 74 in jack housing 70. Angled brake release lever 72 is positioned in place by a combination of slot 74, spring 76 and jacking bar 66. A lift dog 78 is captured in second slot 80 and maintained in place by a combination of spring 82 and jacking bar 66. Jack housing 70 also includes an upper guide 84 and a lower guide 86 for capturing jacking bar 66. Upper and lower guides 84 and 86 preferably also include a plastic and preferably nylon tensioning insert 88 for tensioning against jacking bar 66 through tensioning bolt 90 which also serves as a handle stow stop for handle 46 when handle 46 is pivoted in the direction of arrow 92 against a top of bolt 90 in a stowed position. Bolt 90 tensions each insert 88 against each jacking bar 66 to increase the tensional friction against each jacking bar 86 to provide a brake lock adjustment for the release of jacking bar 66 by angled brake release lever 72 when jacking bar handle 46 is in the release position as illustrated in FIG. 6.

The advancement of jacking bar 66 in upper and lower guides 84 and 86 is achieved by a downward stroke on handle 46 which is pivotally attached at pivot 94 on plate 96 which may be screwed, welded or otherwise attached to jack housing 70. The downward jacking of handle 46 in conjunction with pivot 94 results in roller 98, lifting lift dog 78 which wedges jacking bar 66 in lift dog 78 until lift dog 78 contacts the top of slot 80 as illustrated in FIG. 7. Thereafter the upward movement of handle 46 results in the capture of jacking bar in angled brake release lever 72 and releases lift dog 78 from jacking bar 66 by spring 82. This jacking motion is repeated until the A-coil housing is separated from furnace housing 24 and cord 50 is tightened between furnace housing 24 and A-coil housing 22 to stabilize the novel jacks or until A-coil housing 22 is elevated to its desired stored position.

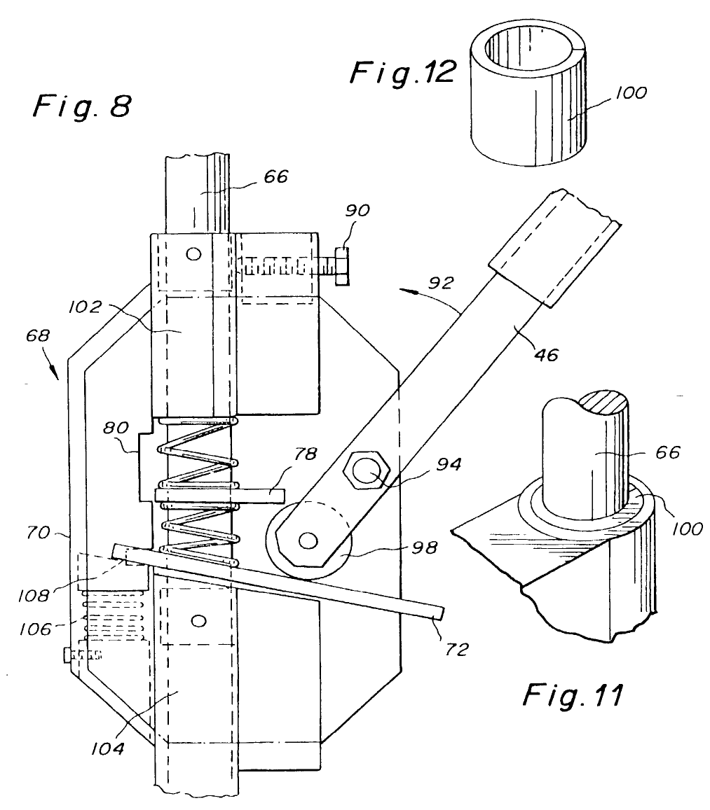

Thereafter handle 46 is placed in its stored position up against tensioning bolt 90 in the direction of arrow 92 as illustrated in FIGS. 6 and 8. Once handle 46 is close to its locked position roller 98 engages and presses downward on angled brake release lever 72 to lock jacking bar 66 toward its locked position as illustrated in FIG. 8. Once handle 46 contacts bolt 90 the jacking mechanism 68 is locked against accidental retraction and conveniently stores handle 46 in a position substantially parallel to jacking bar 66 so that handle 46 does not interfere with the removal of furnace housing 24.

Referring now to FIGS. 8, 11 and 12 an alternative embodiment of the jacking mechanism 68 is illustrated wherein jacking bar 66 is of a circular rather than rectangular configuration. It will be recognized by those skilled in the art that jacking bar 66 may take any geometrical configuration such as square, triangular or other shapes by simple modifying upper guide and lower guide 84 and 86 and changing the configuration of plastic tensioning insert 88 to match the geometrical configuration of jacking bar 66. In the embodiment as illustrated in FIGS. 8, 11 and 12 a corresponding geometrically configured jacking bar 66 includes a circular plastic insert 100 as well as circular upper guide 102 and circular lower guide 104 it will also be recognized that in the embodiment as illustrated in FIG. 8 a spring 106 is biased against the bottom side at end 108 which assists in the operation of jacking mechanism 68 and which is included in jacking mechanisms constructed in accordance with the preferred embodiment of the invention to resiliently bias angled brake release lever against jacking bar 66.

Once furnace housing 24 has been removed or repaired a new furnace housing or repaired furnace housing 24 may be pushed back into position under stored A-coil housing 22 on the novel jacks 20. Once repaired or new furnace housing 24 is in position beneath stored A-coil housing 22 handle 46 is moved from its stored position against bolt 90 to its release position as illustrated in FIG. 6. In its release position angled brake release lever 72 may be lifted upwardly resulting in the retraction of jacking bar 66 resulting in the lowering of A-coil housing 22 over furnace housing 24. Once A-coil housing is lowered to the position as illustrated in FIG. 2 cord 50 is loosened and removed from between A-coil housing 22 and furnace housing 24 before angled brake release lever 72 is again raised to finally lower A-coil housing 22 over furnace housing 24. It will be recognized that the speed of lowering the A-coil housing 22 over furnace housing 24 is controlled by tensioning bolt 90 which tensions tensioning insert 88 against jacking bar 66 to allow the desired speed of lowering the A-coil housing 22 over furnace housing 24.

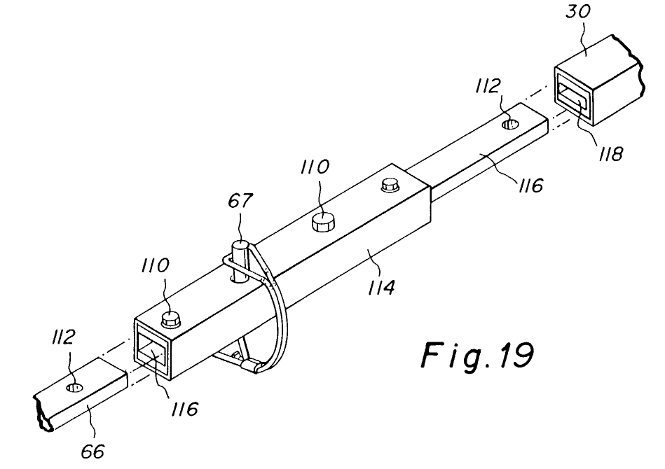

Referring now to FIGS. 1, 3 and 19 novel jacks 20 include one or more adjustment clips 67 or bolts 110 for adjusting for the amount of lift required for A-coil housing 22 in view of the different heights of furnace housing 24. As a result lift plate mechanism 30 includes a plurality of holes for accommodating one or more clips 67 or adjustable bolts 110 for engaging one or more adjustment holes 112 in jacking bar 66. Jacks 20 may also include an extension mechanism 114 (FIG. 1) which may be utilize to extend the length of jacking bar 66 as illustrated in FIG. 19. Extension mechanism 114 can either include an entire lift plate mechanism 30 with stabilizer plates 32 and lift plates 26 or in the best mode of the invention merely include a clip 67 or adjusting bolts 110 together with an opening 116 for receiving jacking bar 66 and at the other end include an extension portion 116 for engaging a slot 118 in lift plate mechanism 30.

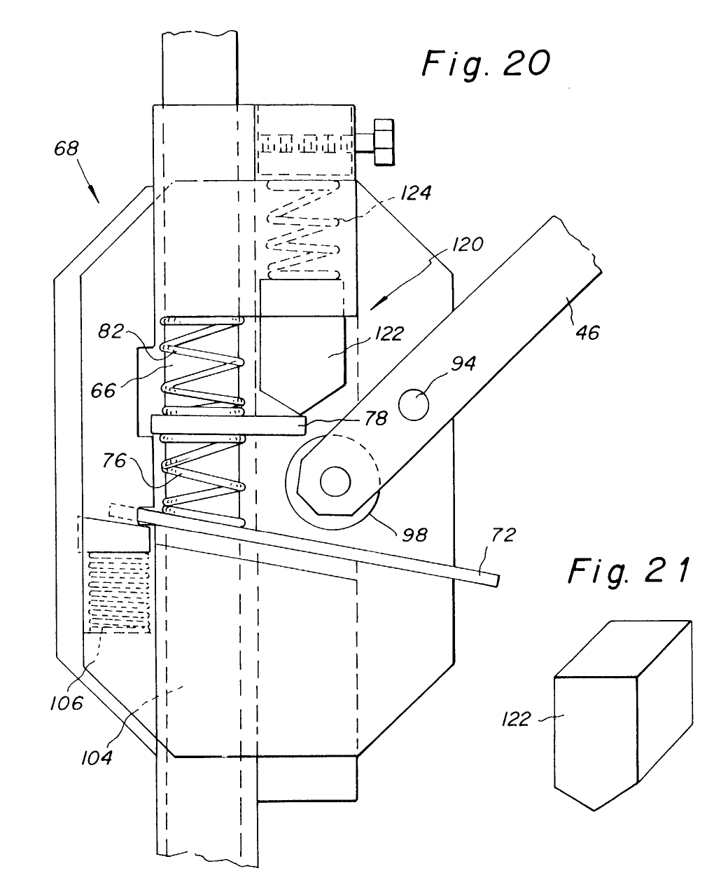

Referring now to FIGS. 20 and 21 a jacking mechanism 68 with a scotching mechanism 120 is illustrated in accordance with the best mode of the invention. The scotching mechanism 120 prevents surface cutting, scoring or abrasion of jacking bar 66 when too much weight is placed on lift plate mechanism 30 or the novel jacks 20 are used for improper purposes to lift weights more than the A-coil which typically weigh between 25-75 pounds. The novel pair of jacks are designed to lift about 100 pounds which is divided equally between the two novel jacks that are designed to each bear around 50 pounds apiece.

The scotching mechanism 120 includes an insert 122 which is preferably made of nylon or other hard elastomeric material. Insert 122 is biased downwardly on lift dog 78 by spring 124. The downward force exerted by insert 122 on lift dog 78 prevents excessive loads on jacking bar 66 from wedging the confronting opening in lift dog 66 from biting into jacking bar 66 and damaging jacking bar 66, lift dog 78 or jacking mechanism 68. As will be recognized by those skilled in the art other types of scotching devices may be employed with jacking mechanism 68.

As will be recognized by those skilled in the art the invention is capable of numerous changes and modifications in the configuration of the jacking mechanism without departing from the method and spirit of the invention which include the novel lift plate mechanism and tensioning cord for stabilizing the lift plate mechanisms with respect to the A-coil housing. It will be further recognized that the cord 50 can be changed or modified to other types of cords, wires or bungee cords with different types of tensioning mechanisms for tensioning the cord between the A-coil housing and furnaced housing in accordance with the invention.

It will be further recognized that in the preferred embodiment of the invention the jacking mechanism includes a novel pivot and roller relationship for jacking and locking the handle in a position so as not to interfere with the removal of the furnace from the elevated and stored A-coil. It will further be recognized that many changes and modifications can be made in addition to those changes and modifications as heretofore discussed and such changes are within the spirit and scope of the invention as will be included in the claims. Such changes and modifications by those skilled in the art may include the modification of the scotching mechanism to prevent damage or misuse of the novel jacks.

As used herein and in the following claims, the word ‘comprising’ or ‘comprises’ is used in its technical sense to mean the enumerated elements include but do not exclude additional elements which may or may not be specifically included in the dependent claims. It will be understood such additions, whether or not included in the dependent claims, are modifications that both can be made within the scope of the invention. It will be appreciated by those skilled in the art that a wide range of changes and modification can be made to the invention without departing from the spirit and scope of the invention as defined in the following claims:

What is claimed is:

1. A jack comprising:
(a) a housing containing a lift dog, a brake release and a jacking bar disposed between said lift dog and said brake release;
(b) a jack handle having a handle end and an actuating end and a pivot disposed therebetween connecting said jack handle to said housing said jack handle having a pivotable jacking position for activating said lift dog with said activating end and a pivotable locked position for locking said brake release with said activating end of said jack handle.

2. The jack of claim 1 further comprising a lifting mechanism including a lift plate, a cord and a tensioning device for tensioning said cord.

3. The jack of claim 1 further comprising a scotching mechanism.

4. The jack of claim 2 further comprising a scotching mechanism.

5. The jack of claim 4 further comprising a locking bar tensioning mechanism.

6. The jack of claim 5 wherein said locking bar tensioning mechanism includes a nylon insert and tensioning screw.

7. The jack of claim 1 wherein said actuating end terminates in a roller.

8. The jack of claim 2 further comprising a second jack with a second lift plate connected by said cord to said lift plate.

9. A pair of connected jacks comprising:
(a) a pair of jack mechanisms for raising a pair of jacking bars;
(b) a pair of lift plates wherein each lift plate of said pair of lift plates is disposed on each one of said pair of jacking bars;
(c) a cord connecting said pair of lift plates; and
(d) a tensioning device for tensioning said cord between said pair of lift plates.

10. The pair of connected jacks of claim 9 further comprising activating means in said pair of jack mechanisms for coordinating the raising of said pair of jacking bars.

11. The pair of connected jacks of claim 10 wherein said activating means is a lift dog slot of the same length on each of said pair of jack mechanisms.

12. The pair of connected jacks of claim 9 wherein each pair of said jack mechanisms includes a scotching device.

13. The pair of connected jacks of claim 9 wherein each pair of jack mechanisms includes a locking bar tensioning mechanism.

14. The pair of connected jacks of claim 9 wherein each pair of jack mechanisms includes a pivotable jack handle pivotable between a jacking position and a stowed position substantially perpendicular to said pair of jacking bars for locking a brake release on said pair of jacks.

15. The pair of connected jacks of claim 9 wherein each of said lift plates is angled.

16. The pair of connected jacks of claim 9 wherein each of said lift plates is adjustable.

17. A method of separating an A-coil from a furnace comprising:
(a) inserting a first lift plate and a second lift plate in the seam between the furnace housing and A-coil housing;
(b) first jacking said first and second lift plate to separate said A-coil housing from said furnace housing;
(c) tensioning a cord between said first lift plate and said second lift plate to stabilize the lift plates with respect to said A-coil housing and a jacking means;
(d) jacking to elevate said A-coil housing to a desired stored position; and
(e) removing said furnace housing from beneath said A-coil housing in said stored position on said jacking means.

18. The method of claim 17 further comprising the step of moving the base of the jacking means away from said furnace housing.

19. The method of claim 17 further comprising the step of removing obstructions between said A-coil housing and said furnace housing that would interfere with said A-coil housing moving upwardly prior to said step of first jacking.

20. The method of claim 17 wherein said step of first jacking to separate said A-coil housing from said furnace housing is terminated when said A-coil housing clears a lip on said furnace housing.
